(19) United States
(12) Patent Application Publication
(10) Pub. No.: US 2026/0056221 A1
(43) Pub. Date: Feb. 26, 2026

(54) METHOD FOR MIXING FLUIDS

(71) Applicant: HOMBRECHTIKON SYSTEMS ENGINEERING AG, Hombrechtikon (CH)

(72) Inventors: Konstantin LUTZE, Uerikon (CH); Harald QUINTEL, Steckborn (CH)

(21) Appl. No.: 19/295,977

(22) Filed: Aug. 11, 2025

(30) Foreign Application Priority Data
Aug. 22, 2024 (EP) 24196028.5

(51) Int. Cl. G01N 35/10; B01F 23/40; B01F 23/45; B01F 31/65; B01F 101/23

(52) U.S. Cl. CPC G01N 35/10; B01F 23/405; B01F 23/45; B01F 31/651; B01F 2101/23; G01N 2035/1058

(57) ABSTRACT

A method for mixing fluids includes providing a pipette tip for receiving a fluid, receiving a first fluid into the pipette tip, receiving a second fluid into the pipette tip, and mixing and analyzing the first and the second fluid in the pipette tip. The method enables resource-saving, safer, more accurate and faster mixing of fluids.

### CROSS-REFERENCE TO RELATED APPLICATION

This application claims priority to European Application No. 24196028.5, filed Aug. 22, 2024, the contents of which are hereby incorporated herein by reference.

### TECHNICAL FIELD

The disclosure relates to a method for mixing fluids, to a pipette tip for use in a method for mixing fluids, to a pipetting device for use in a method for mixing fluids, and to an automatic pipetting machine for use of pipetting devices.

### BACKGROUND

In the state of the art, a method is used in which fluids are mixed by taking a first fluid from a vessel and dispensing it into a second vessel in which a second fluid is present. Here, the two fluids are then mixed. The mixing takes place by pipetting up and down the fluids in the second vessel.

A pipette is used for receiving the fluids. Usually, pipettes are used in the medical field, wherein pipette tips are used as disposable articles made of plastic in order to avoid contamination. For small volumes, so-called micropipettes are used, wherein small volumes of approximately 1 microliter and more can be pipetted. For repetitive work, there are electronically controlled pipettes, which are also used in particular in laboratory machines and laboratory robots.

Some pipettes work according to the displacement principle, wherein a movable piston displaces or draws air, whereby a liquid passes out of or into the pipette tip.

As an alternative to the displacement principle, there are pipettes in the state of the art which work according to the air cushion principle. A corresponding pipetting device is known for example from DE10237770A1. Here, an air column separates the liquid sucked up in the pipette tip and an interior space of the pipette. Due to the movement of a pump element of the pump, a negative pressure arises in the pipette tip, which causes the liquid to rise into the tip. The air column moved by the pump element ensures a fluid stream, due to which the movement of the liquid into or out of the pipette tip takes place.

### SUMMARY

It has been discvered that several problems arise from the state of the art. Thus, for example, each refilling step is a potential source of error. Due to inattention of the laboratories, errors in the machines or the pipettes used, measurement inaccuracies can occur, which negatively influence the result. Likewise, each individual method step involves the risk of spilling the processed fluids/samples. However, this is something that should be avoided in everyday laboratory life with regard to the health of the workers on site and the usually cost-intensive and time-intensive production or procurement of the samples.

In order to enable a sterile mode of operation, it is necessary in the state of the art to change the pipette tip after each working step. This means that, after repipetting the first fluid from the first container into the mixing container, the pipette tip has to be exchanged for a fresh one before the second fluid can be added from the second container into the mixing container.

This necessary change of the pipette tip is a cost factor and a process that requires many resources. The changing of the tips requires time and resources. In addition, it represents an environmental pollution, because each individual pipette tip has to be produced, packaged in a sterile manner and transported to the respective site of use. The same applies to the production and provision of the mixing containers in which the fluids are mixed. They are also single-use products that have to be disposed of after use. Just as with the pipette tips, these used mixing containers have to be produced and delivered separately and disposed of after use, which likewise requires various resources, such as time, raw materials and money.

In the method according to the state of the art, it is moreover not possible to follow the entire mixing process and reactions potentially taking place during it. This is because as soon as the second fluid is added to the first in the mixing container, the mixing process starts. The first reactions begin to run while the mixing process is still in progress and before the completely mixed fluid can be transferred from the mixing container into an analysis container in which the fluid and the reactions taking place therein can be monitored and analyzed. This results in an information gap over the time period from the beginning of the mixing to the beginning of the analysis, so that all collected data and measured values are incomplete and thus inaccurate.

The object of the present disclosure is to provide a method which eliminates the disadvantages known from the state of the art. In particular, to improve a method for mixing fluids in such a way that a more resource-saving, safer, more accurate and faster mixing of fluids is made possible.

This object is achieved according to the disclosure by a method for mixing fluids, a pipette tip for use in a method for mixing fluids, a pipetting device for use in a method for mixing fluids, and an automatic pipetting machine for use of pipetting devices.

The disclsoure relates to particularly advantageous embodiments.

According to the disclosure, a method for mixing fluids is proposed, which comprises the following steps: providing a pipette tip for receiving a fluid, receiving a first fluid into the pipette tip, receiving a second fluid into the pipette tip, and mixing and analyzing the first and the second fluid in the pipette tip.

By receiving the first and the second fluid into the same pipette tip, one pipette tip can be saved, so that the above-mentioned positive effects of saving resources are achieved. In addition, the individual refilling of each fluid into the mixing container is dispensed with, since the fluids are received directly from their respective container into the mixing container, in this case the pipette tip. This results in the advantages already mentioned above of a faster, more efficient and safer mode of operation as a result of the omitted refilling step.

The mixing and analyzing of the fluids in the pipette tip in this case allows monitoring and measurement of the entire mixing process and the reactions taking place in this case from the beginning of the mixing process to the end of the reactions involved, so that no information gap occurs here and the data obtained are complete and thus more accurate than those obtained with methods from the state of the art.

In addition, the analyzing of the fluids in the pipette tip saves time, since the fluids/samples do not first have to be transferred into a separate analysis device for this purpose. The omission of this step and of the analysis device in turn saves other resources in addition to time.

It goes without saying that more than two fluids can also be mixed and analyzed with the method according to the disclosure. For the sake of better readability, however, only a first fluid and a second fluid are mentioned in the following.

In an exemplary embodiment, the analysis can take place while the first and second fluid are mixed. Thus, the entire mixing process can be analyzed, and conclusions can thus be drawn about the entire sequence. In addition, this has the advantage that the start time and the end time of the mixing can be determined exactly. Thus, further statements can be made about the mixing and, if appropriate, the reaction sequence, and the analysis results can be compared exactly with the time sequence.

In an exemplary embodiment, the content of the pipette tip, that is to say the first fluid and/or the second fluid, can be analyzed by an analysis element, in particular the fluid resulting from the mixture can be analyzed by the analysis element. The analysis element is preferably a device which can determine at least one parameter or measured value about the fluid, wherein it has a sensor which can measure the corresponding parameter and its course over time. Preferably, the analysis element also has an emitter which can emit all the necessary signals, in particular radiation, which are necessary for the analysis by the sensor. This combination of emitter and sensor is referred to in the context of this application as an analysis unit, which can be part of the analysis element in particular. For example, photometry can be used for the analysis itself.

In photometry, the emitter emits light in at least one bandwidth, so that it penetrates through the fluid and can be detected by the sensor on the other side of the fluid. A statement about the optical density of the fluid can thus be made by the difference of emitted light and detected light. For the calculation of this data, a calculation module can be used which is both comprised by the analysis element and can be an external part. It goes without saying that other analysis methods than photometry can also be used for this purpose, which are known to the person skilled in the art. For example, the analysis element can emit radiation and detect the change which this radiation undergoes when passing through the pipette tip and thus permit conclusions about the first and/or second fluid in the pipette tip. In this way, the absorption of the first and/or of the second fluid is thus measured and analyzed. The radiation can be, for example, polychromatic X-ray radiation for X-ray fluorescence analysis, radio radiation, visible light and/or UV-VIS radiation. It is also conceivable that, with a similar construction, other parameters of the first fluid and/or second fluid such as, for example, temperature, fluorescence or the electrical conductivity can be monitored and used for the analysis.

In a further method according to the disclosure, the analysis element can analyze the first fluid and/or the second fluid by a camera, in that an optical monitoring takes place. This has the advantage, inter alia, that the camera can perceive and record radiation beyond the visible spectrum or the perception threshold of the human eye and can thus provide new information.

In a further method according to the disclosure, the second fluid can be a reagent, a dye or a marker. In contrast to dye and marker, the reagent is a fluid which reacts with the first fluid and forms at least one third substance, which is used, for example, in a further method or is a desired product of the reaction of the first fluid with the second fluid.

Dyes and markers, on the other hand, are fluids which are primarily used for monitoring the mixing process and/or the reactions taking place therein. Dyes, for example intercalating dyes, can be used to detect substances or substance quantities in a mixture and thus draw conclusions about the composition of the mixture.

Markers, for example radioactive or fluorescent markers, fulfil a similar purpose to dyes. However, since they frequently bind even more specifically than dyes, it is thereby possible to determine finer differences in the composition of the mixture. Moreover, markers can make it possible to mark structures already before or at the beginning of the mixing process and to remain bound by their high binding specificity until the end of the mixing process and the reactions associated therewith, whereby the path of these structures can be traced during the entire process. This allows a deep insight into the sequence and the mode of operation of the processes investigated. Furthermore, fluorescent dyes can be used to determine the progress of the reaction. For example, by monitoring whether the fluorescence changes. Should this no longer be the case, it can be assumed that the mixing process and the reaction associated therewith have ended.

In a preferred method, the first fluid and the second fluid can be mixed by moving up and down in the tip. By moving up and down, a uniform and rapid mixing is made possible without exerting a strong mechanical load on the fluids. Especially when mixing fluids which contain fragile structures such as cells, macroproteins or amino acid sequences, this is important so that their structure and thus mode of operation is not disturbed.

In a preferred method, when receiving the second fluid into the pipette tip, an air cushion can be introduced in the pipette tip between the first fluid and the second fluid, in order to prevent an immediate reaction and thus to define the reaction start point. This has the advantage that it is ensured that the analysis unit is ready for operation before the mixing process begins, so that the entire process can be analyzed and thus, in contrast to the state of the art, no information gap exists, whereby complete data can be generated.

In a preferred embodiment of the method, the second fluid can be received from a second container into the pipette tip, wherein the second container is preferably a cuvette and/or wherein, for mixing the fluids, the entire volume of the pipette tip and of the second container can be used as a mixing chamber. This has the advantage that the mixing process can be carried out more quickly, because more volume is available for mixing. In addition, larger sample volumes can also be mixed more easily, because not only the volume of the pipette tip is available for this purpose, but also that of the second container.

In a preferred embodiment of the method, the second container can be flow-connected to the pipette tip and the first fluid and the second fluid can be pipetted up and down during the mixing process in such a way that the entire volume of the pipette tip and of the second container can be used as a mixing chamber. In addition to the advantages of a faster mixing and the processing of larger volumes, as already described above, the flow connection between the second container and the pipette tip enables a safer mode of operation. The flow connection prevents an undesired escape of the processed fluids, so that the safety in the laboratory is increased when working with potentially harmful fluids. In addition, it is possible to work even more quickly in this way, because precisely that risk of the escape of the fluid or fluids is minimized. This is equivalent to a reduction in costs, because the fluids, which are often expensive and time-consuming to produce, are thus less frequently spilled and thus lost.

In a preferred embodiment of the method, the start time of the mixing process and/or the end time of the mixing process can be determined by the analysis of the interior space of the pipette tip and/or the pipette tip can comprise a measuring window for analyzing the content of the pipette tip. The measuring window can be attached to the pipette tip in such a way that the mixing process can be analyzed through the measuring window by the analysis element. In addition to the advantages already mentioned above, which bring about the determination of the start time or the end time of the mixing process by the analysis of the interior space of the pipette tip, this preferred method has a further advantage. The measuring window enables an analysis which is influenced as little as possible by the fact that the analyzed fluids are present in the pipette tip. Radiation, and in particular radiation of the visible spectrum, as is used, for example, in photometry, is influenced or refracted by the material and the thickness of the pipette tip wall/of the pipette tip body. The use of a measuring window is therefore suitable for reducing these interference factors, without completely replacing the properties of the material of the pipette tip wall/of the pipette tip body that are necessary and advantageous for the actual pipette tip. The measuring window is arranged only in the region of the beam path of the analysis unit, so that this can take place as unhindered as possible.

The measuring window (or also the entire pipette tip) can consist of a transparent plastic or other optically transparent materials known to the person skilled in the art, which are suitable for installation in a pipette tip.

In the context of the disclosure, optically transparent means that the measuring window (at least in a region of the measuring window) is transmissive for electromagnetic waves/radiation, in particular for electromagnetic waves/radiation in the UV/vis range and/or NIR range or for the primary radiation.

In particular, an amorphous polymer can be used as transparent plastic. Here, the pipette tip and in particular the measuring window can comprise a cycloolefin copolymer. Cycloolefin copolymers are generally obtained by metallocene-catalyzed copolymerization of cycloolefins with alk-1-enes. In contrast to partially crystalline polymers such as polyethylene and polypropylene, cycloolefin copolymers are amorphous and thus optically transparent. Due to the low birefringence and optical transparency, the cycloolefin copolymers can be used particularly preferably for the optical analyses according to the disclosure (by the analysis element).

This has the advantage that the influence of the pipette tip body/of the pipette tip wall on the analysis of the fluid can be reduced, so that this problem known from the state of the art can be solved.

Likewise, the pipette tip and/or the measuring window can be produced from glass. Glass has the advantage over plastics that it is less susceptible to color changes which are caused, for example, by long storage times or incident radiation such as UV radiation. In addition, glass is less susceptible to scratches than most plastics. Both, the color fastness and the scratch resistance can reduce the influence that the pipette tip wall/the pipette tip body has on the measuring process.

In a preferred embodiment of the method, the second container can be a cuvette, wherein the cuvette has a measuring window, and the measuring window is attached to the cuvette in such a way that the mixing process can be analyzed through the measuring window by the analysis element. This has the advantage that the process can be observed and analyzed particularly advantageously not only in the pipette tip by a measuring window, but that this is also possible in the cuvette, so that the quality of the data obtained during the analysis can be increased. In addition, in this way, for example, a dye can be aspirated which is already present in the cuvette and its mixture/reaction with the fluid or fluids which is/are already present in the pipette tip can be investigated. Of course, instead of the dye, another fluid can also be aspirated from the cuvette into the pipette tip. Here, too, it is possible, by the aspiration of an air cushion between the fluid or fluids already present in the pipette tip and the fluid aspirated from the cuvette, to plan and determine the start of the mixing exactly in time.

In addition, the use of the second container and of the cuvette in particular offers the possibility of disposing of the entire sample and the vessels used after the mixing and analysis process in one working step.

In addition, a pipetting device according to the disclosure for dosing a liquid by a fluid stream in a method according to the disclosure is proposed. The pipetting device comprises a means for filling the pipette attached to the pipetting device with the fluid stream, wherein the pipette tip is flow-connected to the means for filling and emptying. As a result, a fluid can be received into the pipette tip by the pipetting device.

Furthermore, an automatic pipetting machine according to the disclosure comprising a pipetting device according to the disclosure and a movement device for moving the pipetting device is proposed.

Furthermore, a pipetting device according to the disclosure for dosing a liquid by a fluid stream is proposed, wherein the pipetting device comprises a means for filling and emptying a pipette tip attached to the pipetting device with the fluid stream, wherein the pipette tip is flow-connected to the means for filling and emptying. The means for filling can be, for example, a pipette plunger. This can be operated manually or automatically. Of course, other means are also conceivable which are suitable for generating a fluid stream.

In a preferred exemplary embodiment of a pipetting device according to the disclosure, the means for filling and emptying can be a device for generating or changing a pressure, in particular a pump with a pump chamber for generating a fluid stream. Such a pump has the advantage, inter alia, that the volume of the fluid stream can be determined, controlled and set exactly.

In a preferred exemplary embodiment of a pipetting device according to the disclosure, the device comprises a plurality of pipette tips. It is thereby possible to analyze the content of several pipette tips in parallel. This results in advantages both for automation and for parallel work. In particular for parallel work with identical samples, but also with different samples.

In this case, a cuvette can likewise be arranged on the pipette tip of the pipetting device according to the disclosure in order to allow mixing of the first and the second fluid both in the pipette tip and in the cuvette.

Furthermore, an automatic pipetting machine according to the disclosure is proposed, comprising a pipetting device according to the disclosure, and a movement device for moving the pipetting device in space/automatic pipetting machine. In addition, the automatic pipetting machine can comprise an analysis apparatus for carrying out the analysis of the fluid in the pipette tip.

A pipetting device according to the disclosure can be moved in all spatial directions by the movement device. By the movement device, it is possible to move the pipetting device exactly, and thus to increase the quality of the work, since the pipetting device does not have to be held by hand. This reduces the occurrence of errors in the filling of pipette tips due to incorrect or poor positioning of the pipette tip with respect to the container filled with the first and/or second fluid. In addition, in addition to this source of error, the risk potential for the persons on site is also reduced, since spilling of the samples by the user is avoided.

In a preferred exemplary embodiment of the automatic pipetting machine according to the disclosure, the automatic pipetting machine can comprise a plurality of pipetting devices. This has the advantage that it is possible to work in parallel and thus the above-described advantages of the increased work quality, speed and safety can also be used in the automatic pipetting machine.

In a further exemplary embodiment of the automatic pipetting machine according to the disclosure, the automatic pipetting machine has a control module for controlling the movement device. This control module allows remote-controlled and automated operation of the pipetting device. This results in particular in the known advantages of automation. Thus, the error rate can be reduced, the consistent quality of the work can be ensured and, at the same time, time and thus costs for production and personnel can be saved.

In a preferred exemplary embodiment of an automatic pipetting machine according to the disclosure, the automatic pipetting machine and/or the pipetting device has a sensor module which can provide the control module with information for automated control of the movement device. By this information, it is possible to check and, if appropriate, correct the position of the individual components of the automatic pipetting machine with respect to one another, so that the error rate during filling and/or emptying can be reduced. In addition, the use of a sensor module and the associated checking and correction of the position of the parts of the automatic pipetting machine with respect to one another allows an autonomous mode of operation. As a result, personnel resources are freed, since the time that is necessary for control and monitoring of the automatic pipetting machine can be reduced. In addition, safety is thus also increased, since no persons come into contact with the substances during working.

The transmission of the information can take place via a cable connection or wirelessly. In the wireless transmission of information, the data/signal transmission takes place via free space (air or vacuum) as transmission medium. The transmission can take place by directional or non-directional electromagnetic waves. Bluetooth or WLAN is preferably used in this case.

In a preferred automatic pipetting machine according to the disclosure, the device comprises a storage container for pipette tips. This allows faster processing, because new pipette tips can be provided directly and can thus be received quickly. In addition, the provision of a storage container with pipette tips minimizes the probability of contamination, since it is less frequently necessary to interact with the automatic pipetting machine from the outside.

The device can likewise comprise a storage container for pipette tips which offers the same advantages as the storage container for pipette tips.

In order to reduce the risk of contamination even further, the automatic pipetting machine or at least the pipetting device can be arranged in a housing. In particular, the housing encloses the automatic pipetting machine or the pipetting device in all directions, so that the housing forms a treatment space in which it is possible to work under a hermetically sealed atmosphere. However, beneficial effects are also already achieved by a housing without hermetic sealing. In addition, a simple partition wall for reducing draft air or a cover which can be arranged around the automatic pipetting machine or the pipetting device is also conceivable.

One advantage of the pipette tip according to the disclosure is in particular that known laboratory machines and pipetting devices can be simply upgraded to an automatic pipetting machine according to the disclosure or a pipetting device according to the disclosure, since the pipette tips already present can be exchanged by the pipette tips according to the disclosure.

The retrofitting of an analysis apparatus into known laboratory machines and pipetting devices is also conceivable and possible.

It goes without saying that the exemplary embodiments mentioned here have no limiting character and the various features of the exemplary embodiments and the exemplary embodiments themselves can be combined with one another.

### BRIEF DESCRIPTION OF THE DRAWINGS

In the following, the invention is explained in more detail on the basis of exemplary embodiments with reference to the drawings. The drawings show:

FIG. 1 is a schematic representation of a pipette tip known from the state of the art;

FIG. 2 isa schematic representation of a pipette tip for a method according to the disclosure;

FIG. 3 is a schematic representation of a pipette tip for a method according to the disclosure with an analysis element;

FIG. 4A is a schematic representation of a pipette tip for a method according to the disclosure with a high filling level;

FIG. 4B is schematic representation of a pipette tip for a method according to the disclosure with a high filling level;

FIG. 5 is a schematic representation of a pipette tip for a method according to the disclosure with an air cushion;

FIG. 6 is a schematic representation of a pipetting device according to the disclosure;

FIG. 7 is a schematic representation of a pipetting device according to the disclosure with an analysis unit;

FIG. 8 is a schematic representation of an automatic pipetting machine according to the disclosure.

### DETAILED DESCRIPTION

In order to explain a known pipette tip, reference is made in the following to FIG. 1, on the basis of which the state of the art is described in more detail. In order to distinguish the state of the art from the present disclosure, the reference numerals which relate to features of known examples are provided with an inverted comma, while features of exemplary embodiments according to the disclosure are provided with reference numerals which do not bear an inverted comma.

FIG. 1 shows a pipette tip 1′ with a connecting region 30′, a pipette tip wall 2′ and a tip 31′. The pipette tip 1′ can be attached, preferably flow-connected, to a pipetting device (not shown) by the connecting region 30′. As a result, it is possible to receive and/or dispense a fluid into the pipette tip by the pipetting device via the tip 31′.

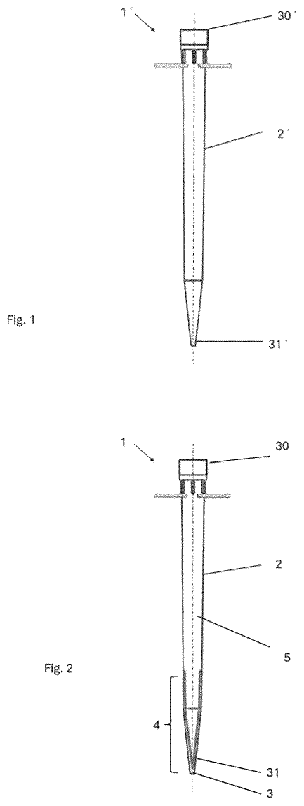

FIG. 2 shows a schematic representation of a pipette tip 1 for a method according to the disclosure with a connecting region 30, a pipette tip wall 2, an interior space 5, a first opening 3, a measuring window 4 and a tip 31. The pipette tip 1 can be attached, preferably flow-connected, to a pipetting device (not shown) by the connecting region 30. A first fluid and a second fluid (not shown) can be received into the pipette tip 1 through the first opening 3. The fluids are then mixed in the interior space 5 of the pipette tip 1 and analyzed via the measuring window 4.

The analysis can also take place during the mixing process.

FIG. 3 shows a schematic representation of a pipette tip 1 for a method according to the disclosure with an analysis element 6, which can analyze the content of the pipette tip 1, in particular the fluid resulting from the mixture (not shown).

The analysis of the first, of the second and/or of the resulting fluid can take place, in particular, in that the analysis element 6 emits radiation and measures the absorption of the first fluid, of the second fluid and/or of the resulting fluid, and/or by photometry, and/or by a camera, in that it carries out an optical monitoring, and/or in that the temperature of the fluids is monitored by a temperature sensor.

The pipette tip 1 shown in FIG. 3 can likewise be used in a method according to the disclosure, in which the second fluid is a reagent, a dye or a marker.

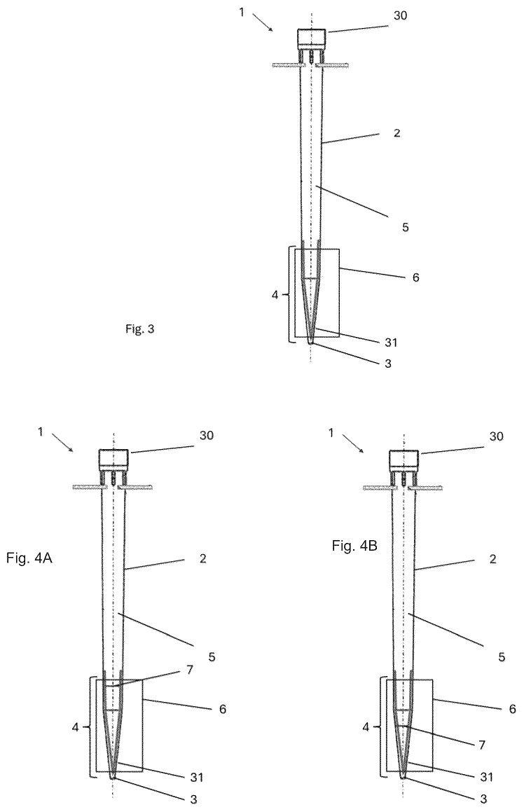

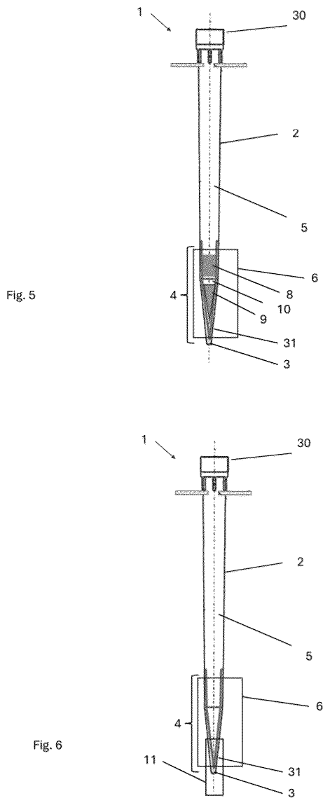

FIGS. 4A and 4B show schematic representations of a pipette tip 1 for a method according to the disclosure with different filling levels 7. The different filling levels 7 arise due to the fact that the first and the second fluid are mixed by moving up and down in the pipette tip.

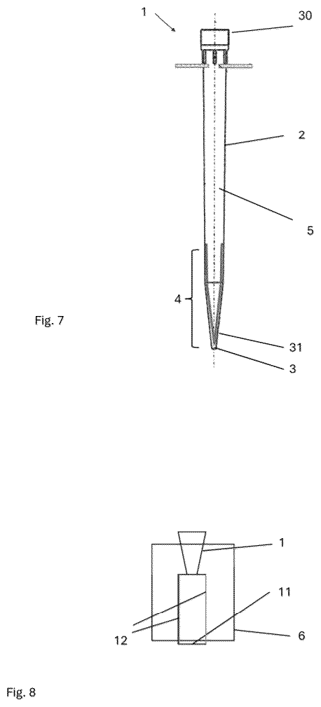

FIG. 5 shows a schematic representation of a pipette tip 1 for a method according to the disclosure with an air cushion 10 between the first fluid 8 and the second fluid 9.

FIG. 6 shows a schematic representation of a pipette tip 1 for a method according to the disclosure, wherein a second container 11 is arranged at the pipette tip, preferably arranged flow-connected, so that, for mixing the first and the second fluid (not shown), the entire volume of the pipette tip and of the second container 11 can be used. The second container 11 is in this case particularly preferably a cuvette.

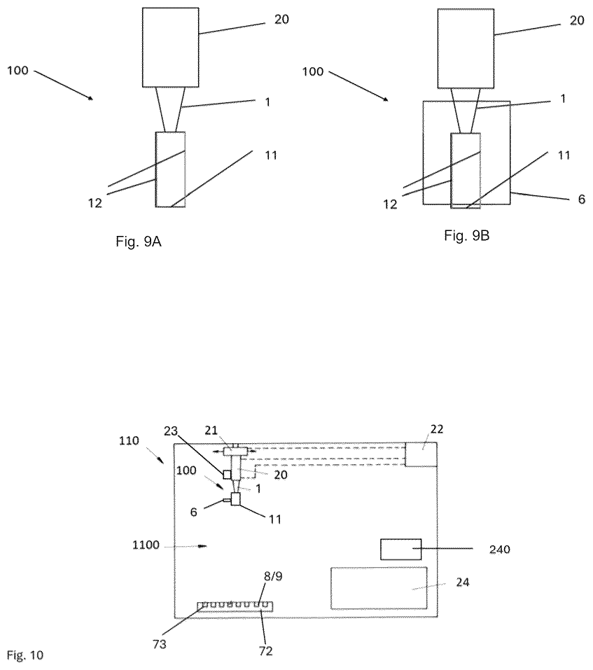

FIG. 7 shows a schematic representation of a pipette tip 1 for a method according to the disclosure, wherein the start time of the mixing process and/or the end time of the mixing process is determined by the analysis of the interior space 5 of the pipette tip 1 and/or the pipette tip 1 comprises a measuring window 4 for analyzing the content of the pipette tip 1, and the measuring window 4 is attached to the pipette tip 1 in such a way that the mixing process is analyzed through the measuring window 4 by the analysis element 6.

FIG. 8 shows a schematic representation of a pipette tip 1 for a method according to the disclosure, wherein the second container 11 is a cuvette, wherein the cuvette has a cuvette measuring window 12, and the cuvette measuring window 12 is attached to the cuvette 11 in such a way that the mixing process is analyzed through the cuvette measuring window 12 by the analysis element 6.

FIGS. 9A and 9B show a schematic representation of a pipetting device 100 according to the disclosure for dosing a fluid by a fluid stream in a method according to the disclosure, wherein the pipetting device comprises a means 20 for filling the pipette tip 1 attached to the pipetting device 100 with the fluid stream, wherein the pipette tip 1 is flow-connected to the means 20 for filling and emptying, as well as the schematic arrangement of a second container 11 on the pipette tip 1. FIG. 9B additionally shows the schematic arrangement of an analysis unit 6 on the pipetting device 100.

FIG. 10 shows a schematic representation of an automatic pipetting machine 110 for use in a method according to the disclosure, comprising a pipetting device 100 according to the disclosure and a movement device for moving the pipetting device.

The automatic pipetting machine 110 comprises a treatment space 1100 for receiving the first fluid 8 and the second fluid 9 and a pipetting device 100 according to the disclosure which is arranged in the treatment space 1100 for carrying out at least one processing step on the first fluid 8 and/or on the second fluid 9. In addition, the automatic pipetting machine comprises a fluid module 72 in which fluid containers 73 are arranged.

The automatic pipetting machine 110 in this case comprises a pipetting device 100, and a movement device 21 for moving the pipetting device 100. The movement device 21 allows the movement of the pipetting device 100 in all directions in space.

The automatic pipetting machine 110 in this case can have a plurality of pipetting devices 100.

The automatic pipetting machine 110 in this case has a control module 22 for controlling the movement device 21.

It is possible in this case for the automatic pipetting machine 110 and/or the pipetting device 100 to have a sensor module 23 which provides the control module 22 with information for automated control of the movement device 21.

The automatic pipetting machine 110 in this case has storage containers 24 for pipette tips 1 and storage containers 240 for second containers 11.

What is claimed

1. A method for mixing fluids, comprising:
providing a pipette tip for receiving a fluid,
receiving a first fluid into the pipette tip,
receiving a second fluid into the pipette tip, and
mixing and analyzing the first fluid and the second fluid in the pipette tip.

2. The method according to claim 1, wherein the analyzing includes analyzing while the first and second fluid are mixed.

3. The method according to claim 1, wherein the first fluid and the second fluid in the pipette tip are analyzed by an analysis element.

4. The method according to claim 3, wherein the analysis element emits radiation and measures absorption of the first fluid or of the second fluid to analyze the first fluid or the second fluid.

5. The method according to claim 3, wherein the analysis element analyzes the first fluid or the second fluid by photometry.

6. The method according to claim 3, wherein the analysis element analyzes the first fluid or the second fluid by a camera, in that an optical monitoring takes place.

7. The method according to claim 3, wherein the analysis element analyzes the first fluid or the second fluid, in that a temperature thereof is measured by a temperature sensor.

8. The method according to claim 1, wherein the second fluid is a reagent, a dye or a marker.

9. The method according to claim 1, wherein the first fluid and the second fluid are mixed by moving up and down in a tip.

10. The method according to claim 1, wherein, when receiving the second fluid into the pipette tip, an air cushion is introduced in the pipette tip between the first fluid and the second fluid, so as to prevent an immediate reaction and to define a reaction start point.

11. The method according to claim 1, wherein the second fluid is received from a second container into the pipette tip,, or for mixing the fluids, an entire volume of the pipette tip and of the second container is used as a mixing chamber.

12. The method according to claim 11, wherein the second container is flow-connected to the pipette tip and the first fluid and the second fluid are pipetted up and down during a mixing process such that the entire volume of the pipette tip and of the second container is used as the mixing chamber.

13. The method according to claim 1, wherein a start time of a mixing process or an end time of a mixing process is determined by analysis of an interior space of the pipette tip or the pipette tip comprises a measuring window to analyze a content of the pipette tip, and the measuring window is attached to the pipette tip such that the mixing process is analyzed through the measuring window by an analysis element.

14. The method according to claim 1, wherein the second container is a cuvette, the cuvette has a measuring window, and the measuring window is attached to the cuvette such that a mixing process is analyzed through the measuring window by an analysis element.

15. A pipetting device for dosing a liquid by a fluid stream in a method according to claim 1, comprising:
a device configured to fill the pipette tip attached to the pipetting device with the fluid stream, the pipette tip flow-connected to the device for filling and emptying.

16. An automatic pipetting machine comprising:
the pipetting device according to claim 15; and
a movement device configured to move the pipetting device.

17. The method according to claim 1, wherein the second fluid is received from a second container into the pipette tip, second container is a cuvette, or for mixing the fluids, an entire volume of the pipette tip and of the second container is used as a mixing chamber.

18. The method according to claim 1, wherein a resulting fluid of the first fluid and the second fluid in the pipette tip are analyzed by an analysis elementanalyzed.
